(19) United States
(12) Patent Application Publication
(10) Pub. No.: US 2004/0161153 A1
(43) Pub. Date: Aug. 19, 2004

(54) Context-based detection of structured defects in an image

(76) Inventor: Michael Lindenbaum, (US)

Correspondence Address: HEWLETT-PACKARD COMPANY, Intellectual Property Administration, P.O. Box 272400, Fort Collins, CO, 80527-2400, US

(21) Appl. No.: 10/368,201

(22) Filed: Feb. 18, 2003

(51) Int. Cl. H04N 1/409; G06K 15/00; G06K 9/56

(52) U.S. Cl. 382/209; 358/3.26; 382/205

(57) ABSTRACT

Structured defects in a digital image are detected by examining at least one context-dependent property of candidate image regions of the digital image.

### BACKGROUND

The visual quality of images generated or formed by computers, printers, scanners, facsimile machines, and other image forming devices can be adversely affected by image noise or defects arising from a variety of sources. The defects include artifacts or other noise in the original (clean) image and artifacts or other noise introduced by the image capture, image generation, or image scanning process.

Unstructured artifacts, such as white Gaussian noise, are typically randomly distributed throughout the image. Structured artifacts, such as scratches, dust, dirt, and hair affect discrete locations within the image. They tend to be sparse in the image

Existing image processing methods incorporate some form of image noise filtering. Image noise filtering is accomplished in different ways depending upon the type of noise being filtered.

Filtering of unstructured image artifacts or “global image noise” is generally accomplished by statistically modeling the noise and creating a noise filter based on this model. In general, such global image noise filtering methods compare the global statistical properties of the noise and those of the image in order to filter out or “remove” the noise. Such global image noise filtering methods are ineffectual for detecting and filtering structured artifacts when characterizations of location and/or properties of the artifacts are imprecise.

One known technique for filtering structured image artifacts or “structural image noise” involves creating an image noise filter based upon simplifying assumptions about the nature and characteristics of the structural noise, e.g., the artifacts are small dots or have a periodic structure. This structural image noise filtering technique is generally inaccurate and/or ineffectual.

Another known technique for filtering structured image artifacts or “structural image noise” involves comparing the “contaminated” image being processed with a reference “uncontaminated” image, or comparing the “contaminated” image being processed with related images (e.g., subsequent frames of a motion picture film, after motion compensation), in order to detect the location and properties of the structural image noise. Interpolation in the time and space domain can then be employed to minimize the noise. Of course, this technique for filtering structural image noise is not useful if additional comparison or reference images are unavailable.

### SUMMARY

The present invention encompasses, among other things, a method for detecting defects in an image by examining at least one context-dependent property of a plurality of candidate image regions, and determining which, if any, of the candidate image regions contain a defect. This determination is based at least in part on the examination of the context-dependent properties of the candidate image regions.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a functional block diagram of an exemplary scanner device.

FIG. 2 is a functional block diagram of an exemplary scanner system.

FIG. 2a is a flow chart of a general method for detecting and removing structured artifacts in an image according to an embodiment of the present invention.

FIG. 3 is a flow chart of an exemplary method for detecting structured artifacts in an image according to an embodiment of the present invention.

FIG. 4 is an edge map depicting three different candidate image regions and edgels of adjoining image regions in the vicinity of the three candidate image regions.

FIG. 5 is a diagram illustrating the geometrical construct of a method for calculating a composite value of a co-linearity property for a candidate image region according to an embodiment of the present invention.

FIG. 6 is a diagram illustrating the geometrical construct of a method for calculating a composite value of a T-junction property for a candidate image region according to an embodiment of the present invention.

### DETAILED DESCRIPTION

The present invention encompasses a method for detecting defects in an image. In the exemplary embodiment described in detail herein, the defects that are detected are structured artifacts.

The method can be implemented in a variety of manners. For example, the method can be implemented in software (executable code) that is executable by a dedicated processor of (e.g., the controller of an image forming device) or a general purpose processor (e.g., the processor of a host computer). Depending on the processor, executable code for the processor may be stored in electronic memory, magnetic storage (e.g., a hard drive), optical storage (e.g., a CD), etc.

The term “image forming device” as used herein encompasses any device capable of forming or producing an image on print or visual media, including, but not limited to, digital cameras, ink jet printers, daisy wheel printers, thermal printers, laser printers, facsimile machines, copiers, scanners, and multi-function peripheral devices.

For purposes of illustration, the present invention is described in the context of a scanner device or scanner system. However, the present invention is not limited to this particular context or application, but rather, is broadly applicable to any image forming or image processing application.

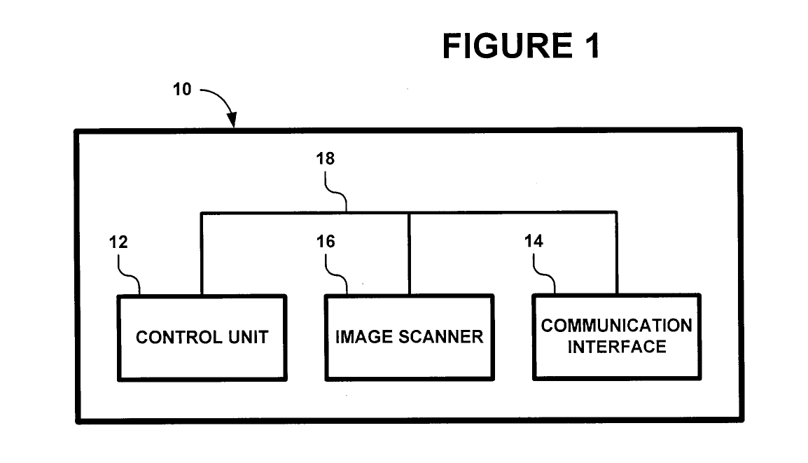

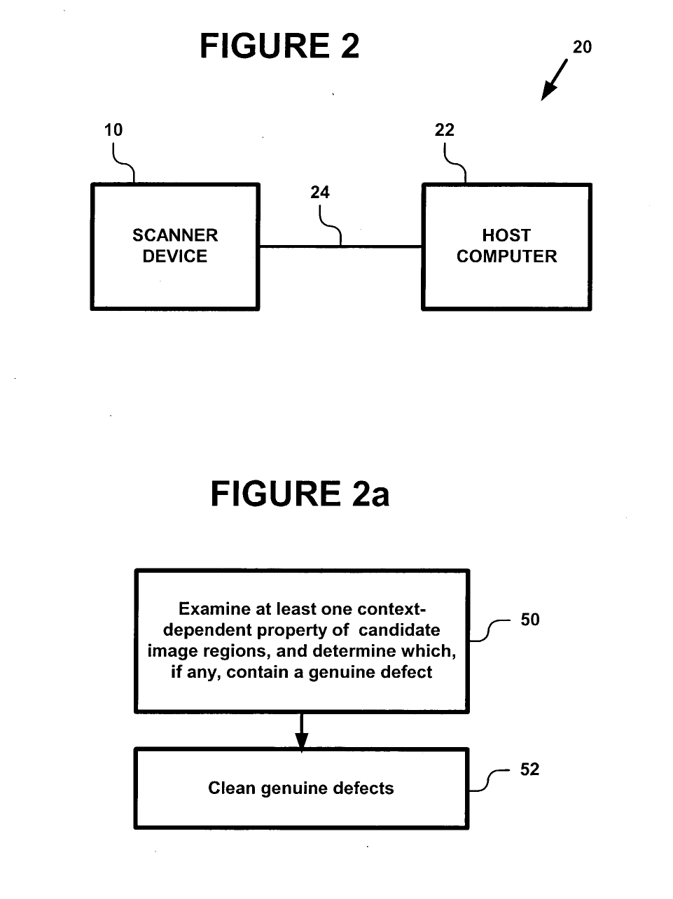

With reference now to FIGS. 1 and 2, an exemplary scanner device 10 includes a control unit 12, a communication interface 14, and an image scanner 16 interconnected via a bus 18. The control unit 12 includes a processor or other logic device programmed to control various functions of the scanner 10. The image scanner 16 is used to convert an original document, such as a photograph or text document, into a digitized image that can be further processed by the processor of the control unit 12 and/or the processor of a host (e.g., a host computer). An exemplary scanner system 20 includes the scanner device 10 and a host 22 connected by a communication link 24.

FIG. 2a shows a general method for detecting and removing structured artifacts in an image. The structured artifacts are detected by examining at least one context-dependent property of a plurality of candidate image regions, and determining which, if any, of the candidate image regions contain a genuine defect (50). This determination is based on the examination of the context-dependent properties of the candidate image regions. It may also be based on context-independent properties of the candidate image regions. Those defects identified as genuine may be cleaned from the original image (52). The defects may be removed by impainting or another suitable method. The defect removal may be automated, thus allowing the defects to be detected and removed without human interaction.

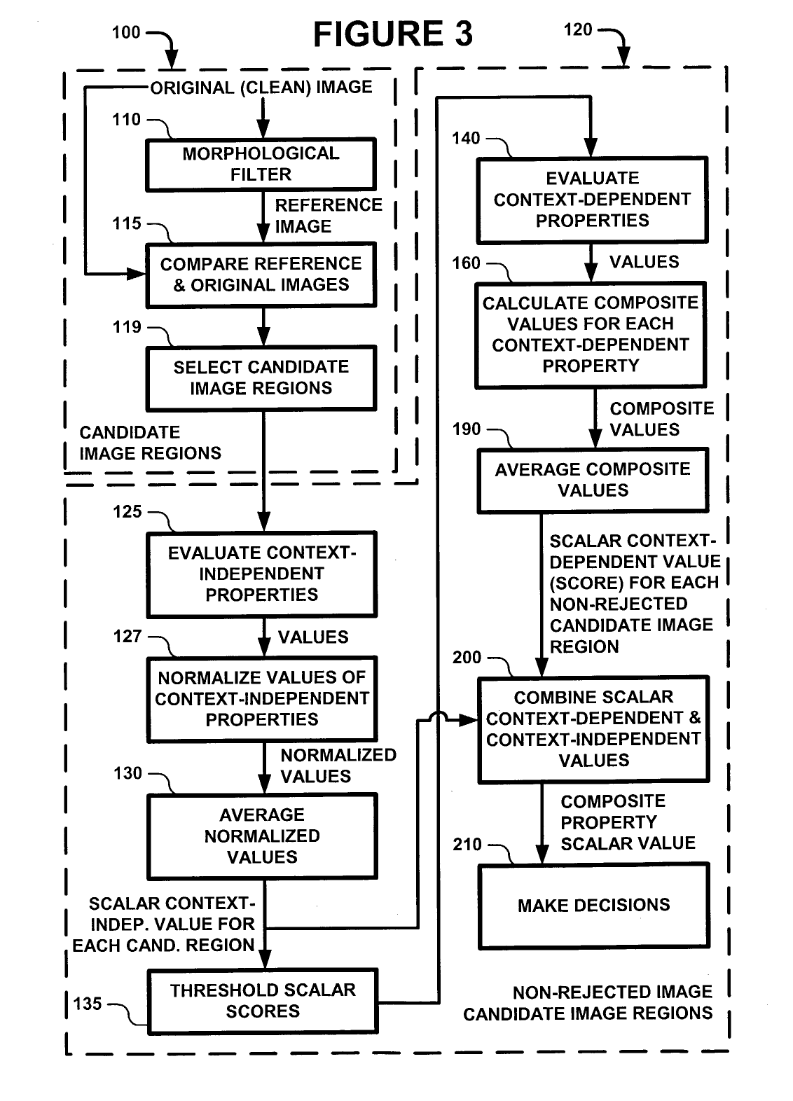

FIG. 3 shows a flow chart of an exemplary method for detecting defects in an image according to an exemplary embodiment of the present invention. The exemplary embodiment is tailored to detect structured artifacts that appear as thin, relatively elongated marks or blemishes on the image that are lighter or darker than the surrounding regions of the image, such as those attributable to scratches, dust, dirt, and/or hairs. However, the method can be tailored to detect other types or classes of defects having different geometric and/or photometric and/or other image properties. In general, as will become more fully apparent hereinafter, the parameters of the discrimination or filtering functions can be adjusted in accordance with the characteristic size, shape, texture, color, hue, brightness, specularity, and/or other image properties of the particular class of defects of interest and/or the image in which they lie.

As can be seen in FIG. 3, the method includes a “candidate selection stage” 100 and a “candidate filtering stage” 120. However, the selection of candidate image regions can be predetermined or determined by an external source, in which case, the method would not include the candidate selection stage 100, but rather, would include only the candidate filtering stage 120. For example, candidate image regions can be selected by a computer program that is separate from a computer program that implements the method of the present invention. Further, the term “candidate image region” as used herein encompasses the following two cases. In the first case, every pixel of the candidate image region is suspected to be a structured artifact. The candidate image regions of the first case usually have different shapes, which are specified by a candidate selection algorithm. In the second case, every pixel in the candidate image region is either suspected to constitute a structured artifact or a part of the original (clean) image. The second case can occur if the candidate selection region is a rough approximation of the pixels suspected to contain structured artifacts, and encompasses more than the pixels suspected to constitute structured artifacts.

In the candidate selection stage 100 of the exemplary embodiment, the image is partitioned into image regions that are suspected to constitute (or contain) a structured artifact, referred to herein as “candidate image regions”, and image regions that are not suspected to constitute structured artifacts, referred to herein as “non-candidate image regions”.

In the candidate filtering stage, the candidate image regions selected in the candidate selection stage (or provided by an external source) are filtered in order to make a determination as to which (if any) of these candidate image regions actually constitute (or contain) a structured artifact. The determination can be implemented as a hard decision as to which of the candidate image regions constitute (or contain) a structured artifact and/or by sorting or ranking the candidate image regions according to the likelihood or probability that they constitute (or contain) a structured artifact. In the latter case, the ranking data may be used for interactively “marking” suspected structured artifacts, and/or to accelerate some further image processing or defect detection process (by eliminating the need to consider all candidate image regions). Generally, the candidate image regions will constitute only a small fraction of the full image being processed, thereby eliminating a large amount of computational effort in the candidate filtering stage that would otherwise be required if the full image was analyzed.

With continuing reference to FIG. 3, in the candidate selection stage 100, a relatively coarse filter or discrimination function can be employed in order to identify or extract the candidate image regions from the full image, whereby the remaining image regions become the non-candidate image regions. In general, structured artifacts are localized, with one or more properties or features that are inconsistent with the properties of its neighborhood (which is usually clean). In contrast, global image noise (such as additive Gaussian noise), is not localized and has properties that are consistent across local neighborhoods.

In the exemplary embodiment, in the candidate selection stage 100, the original image is passed through a morphological filter at step 110, to thereby create a reference image in which thin and relatively bright or dark image regions are missing. For example, a gray level opening type of morphological filter can be used for detecting the thin, relatively bright regions, or a gray level close type of morphological filter can be used for detecting the thin, relatively dark regions. The original image is then compared to the reference image at step 115 to determine differences (e.g., gray level differences) between the corresponding pixels in the two images. The gray level differences between these two images should be far greater than zero only in those thin and relatively bright regions of the original image that are missing from the reference image. The present invention is not limited to a morphological filter. Other techniques may be used to create a reference image that does not have thin, bright regions in the original image.

In the exemplary embodiment, area and gray level difference thresholds are employed at step 119 in order to select the candidate image regions. These difference thresholds can be set anywhere from a low value that increases the number of candidate image regions selected, to a high value that reduces the number of candidate image regions selected, depending upon the wants or requirements of the particular application.

For example, if it is desired to maximize processing speed and/or minimize computational load, the difference thresholds can be set to a high value so as to reduce the number of candidate image regions selected, at the potential cost of a higher incidence of missed (undetected) structured artifacts. If it is desired to minimize the incidence of missed (undetected) structured artifacts, the difference thresholds can be set to a low value so as to increase the number of candidate image regions selected, at the cost of decreased processing speed and/or increased computational load. If it is desired to detect structured artifacts that occupy only a few pixels, then the area threshold can be set to a relatively low value. However, if relatively small artifacts are considered tolerable (e.g., virtually imperceptible) for a given application, then the area threshold can be set to a relatively higher value.

No matter what difference threshold values are chosen, it is still possible that many of the selected candidate image regions will not actually constitute structured artifacts, e.g., due to a certain incidence of relatively thin, relatively bright regions in the original image that are actually part of the original image, as opposed to being alien to the original image. These ambiguities can occur anywhere within the original image, but most commonly occur at the boundaries or facets of objects (due to specularities), on textured surfaces, and other similar locations. If the candidate image region lies on the boundary of an object or macrostructure within the original image, then a detected local brightness of the candidate image region could be due to a specularity effect at transitions between object facets. In this case, it is expected that the candidate image region is actually part of a longer boundary curve.

In the exemplary embodiment, in the candidate filtering stage 120, a combination of image properties are examined in order to sort or rank the candidate image regions according to the likelihood or probability that they contain at least one structured artifact and/or in order to make a hard decision as to which (if any) of the candidate image regions contain at least one structured artifact. In general, the candidate filtering stage 120 can be thought of as a discrimination function that resolves the ambiguities discussed above to thereby discriminate between candidate image regions that are actually part of the original image and those that are alien to the original image. In the following description of the candidate filtering stage 120 of the exemplary embodiment, a combination of “context-independent properties” and “context-dependent properties” of each candidate image region are examined or evaluated. However, the method may be performed by examining or evaluating only one or more context-dependent properties of the candidate image regions, without evaluating or examining any context-independent properties of the candidate image regions.

In the candidate filtering stage 120, one or more (a “set”) of intrinsic image properties (“context-independent properties”) of each candidate image region are examined or evaluated in order to provide a measure of how closely each candidate image region fits or matches a predetermined or learned profile of the structured artifacts being searched for. Additionally, one or more (a “set”) of contextual image properties (“context-dependent properties”) are examined or evaluated in order to provide a measure of the plausibility that each candidate image region actually contains at least one structured artifact as opposed to actually being a part of the original image.

The image under evaluation can be considered to have the following candidate image regions:

a type (1) image region, in which the defect region itself, in which every pixel belongs to the defect;

a type (2) image region, in which a slightly larger image region including both a type (1) image region and a “narrow band” around the type (1) image region; and

a type (3) image region, in which a much larger image region including both a type (2) image region and other portions of the image outside of the type (2) image region.

In general, context-independent properties can be measured or calculated by using data derived from type (1) and/or type (2) image regions, whereas context-dependent properties can be measured or calculated by using data derived from type (3) image regions.

The term context-independent properties as used herein refers to properties or features of an image region of either type (1) or (2) above, which properties are independent of the contextual relationship of that image region to macrostructures or larger regions of the image as a whole beyond the immediate neighborhood of the image region in question. Exemplary context-independent properties include geometric properties such as eccentricity or degree of elongation of a type 1 candidate image region; thinness (e.g., width in pixels) of a type 1 candidate image region; and area (e.g., pixels²). Eccentricity or degree of elongation may be computed as length (in pixels) of long axis/length (in pixels) of short axis of a type 1 candidate image region. Other exemplary properties include photometric properties such as maximum and/or minimum gray level of a candidate image region; average gray level of a candidate image region; and gray level local maximum and/or minimum of a candidate image region.

A determination as to whether a suspected defect is genuine can be made by examining the context-independent properties alone. However, such a determination can be unreliable. However, the examination of the context-independent properties helps in an overall decision, which relies upon context-dependent properties. The examination of the context independent properties can be used to specify the candidate regions (e.g., according to brightness and size); it can be used to increase the reliability of a determination as to whether a suspected defect is genuine; and it can be used to narrow the search for candidate image regions and thereby accelerate processing speed.

The particular context-independent properties may depend upon the particular class of defects of interest.

The term “context-dependent properties” as used herein refers to properties or features of an image region that are dependent upon the contextual relationship of the image region to macrostructures or larger regions of the image as a whole beyond the immediate neighborhood of the image region in question. Context-dependent properties are indicative of whether a suspected defect is alien to the original image or, instead, is part of a larger structure that is part of the original image.

Examination or evaluation of context-dependent properties can provide a measure of the likelihood that a particular image region under consideration constitutes (or contains) a defect (e.g., a structured artifact) that is alien to the original image, or conversely, that the particular image region is part of the original image. Thus, the value of context-dependent properties can represent a measure of the likelihood that a suspected defect is separate and independent from the original image, or rather, is part of a larger structure (“macrostructure”) of the original image. Thus, this value can be thought of as a measure of the plausibility that the suspected defect is genuine, or conversely, a measure of the suspected defect is not part of the original image.

The context-dependent properties can be used to distinguish between genuine defects in an image and false object associated with object boundaries. The presence of object boundaries in the vicinity of the candidate may be detected as the existence of edge elements (edgels). Edgels may be detected as large changes in gray level over a short distance. An edgel may be associated with length and direction and sometimes strength.

Because objects boundaries tend to be smooth, the nearby edgels associated with the same object tend to be roughly collinear. Similarly, a false candidate region on the boundary of an object is expected to be collinear with nearby edgels associated with the same object. Therefore, colinearity of the candidate region and edgels in one or more adjacent region of the original (clean) image would suggest that the candidate image region is not a genuine defect. Thus an exemplary context-based property may be based on the colinearity between candidate regions and nearby edgels.

Further, if the candidate image region lies on an object boundary, it would also be expected that there would be a significant difference in some feature or characteristic of adjacent image regions lying on opposite sides of the object boundary. Therefore, some significant difference in one or more characteristics of these adjacent image regions (e.g., color or texture direction) would suggest that the candidate image region is not a genuine defect. Thus another exemplary context-based property may be based on color and/or texture uniformity between adjacent image regions.

Other context-based properties may be examined to determine whether a candidate image region belongs to a boundary. Consider a candidate image region that belongs to a boundary of an object that is partially occluded by some other object (or some other part of the same object), and lies near the occluding boundary. Such a candidate image region would make a T-junction with the edgels of the occluding boundary. Thus an additional exemplary context-based property is based on the occurrence of a T-junction.

The context-dependent properties are not limited to the occurrence of candidate regions on imaged boundaries. A detected local brightness maximum of the candidate image region could be due to random brightness fluctuations associated with a textured region of the original image. Detecting such a textured region with high brightness variability in the vicinity of the candidate image region constitutes evidence that the candidate image region may be part of the of the original image. Thus, an additional exemplary context-based property could be based on brightness uniformity between the candidate image region and one or more adjacent image regions.

The candidate image region may be a member of a set of similar bright (or dark) regions of the original image that share some common characteristics (e.g., shape, size, brightness, etc.). Thus, an additional exemplary context-based property may be based on brightness (or darkness) uniformity between the candidate image region and one or more other original image regions that have one or more other common characteristics.

In general, considering the class of structured artifacts composed of bright (or dark) thin, elongated image regions that can be approximated as line segments, it would be expected that if a suspected structured artifact (of this class) is genuine (e.g., a “real scratch”), then the location of its endpoints, the line on which it lies, its color, its texture, and/or other characteristics would likely not be related to image content.

In the candidate filtering stage 120 of the exemplary embodiment, at step 125, one or more (the “set” of) specified context-independent properties of each candidate image region selected in the candidate selection stage 100 are evaluated. In the exemplary embodiment, at step 127, the values for each specified context-independent property are normalized for the ensemble of candidate image regions evaluated, so that this ensemble will have zero mean and unit variance for each specified context-independent property (exemplary measurements for obtaining these values will be described below). The normalized values for all specified context-independent properties can be averaged, at step 130, to produce a scalar context-independent score for each candidate image region.

If a hard decision is desired at this juncture as to which of the candidate image regions (if any) constitutes (or contains) a structured artifact(s), such a decision can be made by thresholding the scalar scores obtained for each respective candidate image region, at step 135. In this way, some candidate image regions can be filtered out prior to any further processing, thereby reducing computational overhead and increasing processing speed. In this connection, the steps 125, 127, 130, and 135 can be considered to collectively constitute a pre-filtering (or “coarse filtering”) stage of the candidate filtering stage 120.

In the candidate filtering stage 120 of the exemplary embodiment, at step 140, one or more (the “set” of) specified context-dependent properties of each candidate image region selected in the candidate selection stage 100 are evaluated; or, alternatively, only the context-dependent properties of the candidate image regions selected in the pre-filtering stage of the candidate filtering stage 120 are evaluated. In the exemplary embodiment, co-linearity of the candidate image regions examined with respect to edgels of adjoining image regions in the vicinity of the respective candidate image regions is evaluated.

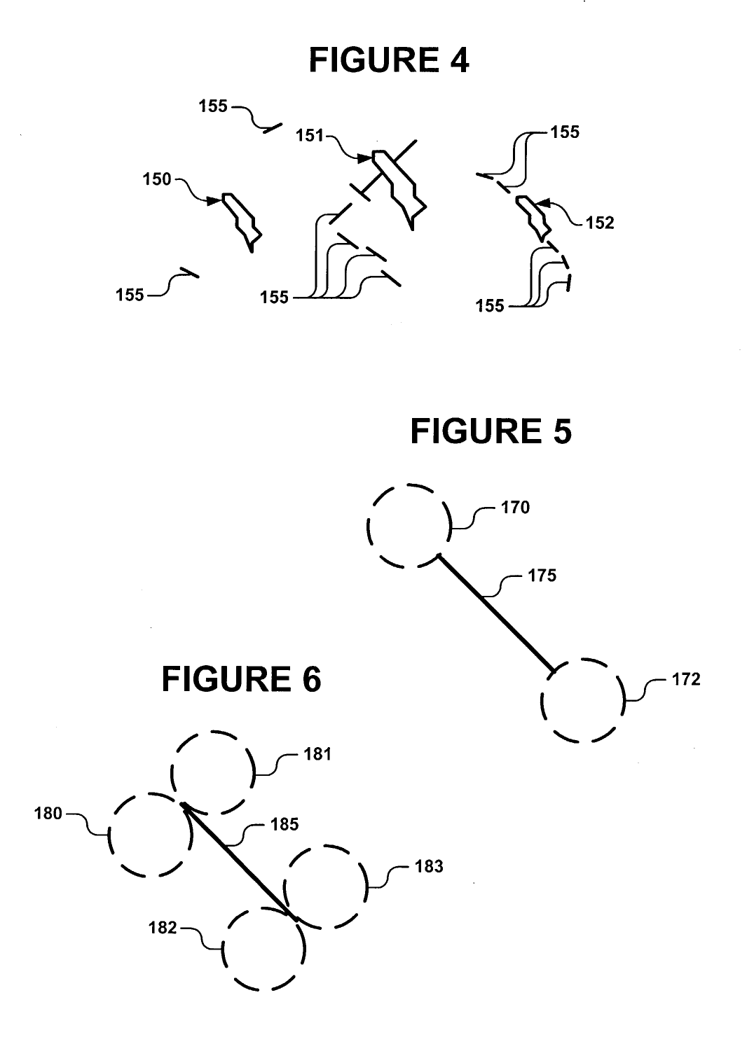

Additional reference is made to FIG. 4, which shows an edge map depicting three different candidate image regions 150, 151, and 152, and edgels 155 of adjoining image regions. As can be seen in FIG. 4, only two unrelated edgels 155 are in the vicinity of the first candidate image region 150; a number of edgels 155 are in the vicinity of the second candidate image region 151, but none of these edgels appear co-linear with the second candidate image region 151; and a number of edgels 155 are in the vicinity of the third candidate image region 152, and these edgels 155 are substantially co-linear with the third candidate image regions 152. This evidence suggests that the first and second candidate image regions 150 and 151 are not part of a macrostructure of the original image, whereas the third candidate image region 152 is part of a macrostructure of the original image.

In general, the number of edgels in the vicinity of the candidate image region, the number of these edgels that are roughly co-linear with the candidate image region (which is approximated to be a line segment), and the degree of co-linearity of the roughly-co-linear edgels with the candidate image region are possible variables whose values can be determined for each candidate image region under examination. The values of these variables can then be combined in any suitable manner.

At step 160 in the exemplary embodiment depicted in FIG. 3, a composite value for these variables is obtained for this context-dependent property of each examined candidate image region. This composite value is indicative of the likelihood that the candidate image region is part of the original image or is a structured artifact. More particularly, in the exemplary embodiment, the composite value of the co-linearity property is calculated as follows, for each examined candidate image region:

1) As is depicted in FIG. 5, two circular regions of interest (ROIs) 170, 172, with centers located on extensions of the candidate image region (viewed as a line segment 175), and having a radius R, are specified. The ROIs 170, 172 can be specified to just touch the opposite ends of the line segment 175. A co-linearity measure is calculated for each ROI separately.

2) Let N be the total number of edgels in the ROI, and let N_{α} be the number of edgels in the ROI which makes a small angle (smaller than a threshold α) with the associated candidate image region.

3) The co-linearity measure for each ROI is (1−e^{-N/R}) N_{α}/N. This co-linearity measure will have a value between 0 and 1, with the value being higher with a greater number N of edgels for the associated ROI, and when a greater number of those edgels are co-linear with (or form a small angle with) the associated candidate image region. The value approaches 1 for a large number of edgels in the ROI and most of them are substantially co-linear with the associated candidate image region.

4) The composite value of the co-linearity property associated with the candidate image region is the sum of the co-linearity measures calculated for the two ROIs associated with that candidate image region.

Alternatively, at step 160, other context-dependent properties of the candidate image region can be examined in addition to or in lieu of the co-linearity property. For example, a T-junction measure can be calculated for each candidate image region under examination. The T-junction measure is indicative of the likelihood that each respective examined candidate image region forms a T-junction with edgels of adjacent image regions.

With reference to FIG. 6, such a T-junction measure could be calculated for each examined candidate image region as follows:

1) As is depicted in FIG. 6, four circular regions of interest (ROIs) 180, 181, 182, and 183, having a radius R, are specified. The center of the ROIs 180, 181 are located on a line perpendicular to the associated candidate image region (approximated as a line segment 185), and passing through one of its ends, and the centers of the ROIs 182, 183 are located on a line perpendicular to the line segment 185, and passing through an opposite one of its ends. The ROIs 180, 181 can be specified to just touch opposite sides of the line segment 185, and the ROIs 182, 183 can be specified to just touch the opposite sides of the line segment 185. A T-junction measure is calculated for each ROI separately.

2) Let N be the total number of edgels in an ROI, and let N_{α} be the number of edgels in the ROI which makes a small angle (smaller than a threshold α) with a line normal to the associated candidate image region.

3) The T-junction measure for each ROI is (1−e^{-N/R}) N_{α}/N. This T-junction measure will have a value between 0 and 1, with the value being higher with a greater number N of edgels for the associated ROI, and when a greater number of those edgels are co-linear with (or form a small angle with) the line normal to the associated candidate image region. The value approaches 1 when there are a large number of edgels in the ROI that are substantially co-linear with the line normal to the associated candidate image region.

4) The composite value of the T-junction property associated with the candidate image region is the sum of the T-junction measures calculated for the four ROIs associated with that candidate image region.

With reference again to FIG. 3, at step 190, the composite values of all context-dependent properties for each examined candidate image region can be averaged to produce a scalar context-dependent value for each examined candidate image region.

At step 200, the scalar context-independent value and the scalar context-dependent value for each candidate image region that passed through the pre-filtering stage of the candidate filtering stage 120 can be combined (e.g., simply added) to thereby yield a composite property scalar value that can be used to make a hard decision, as at step 210, as to which of the candidate image regions contain at least one structured artifact and/or to sort or rank the candidate image regions according to the likelihood or probability that they constitute (or contain) a structured artifact(s). In particular, in the exemplary embodiment, the composite property scalar value is compared to a prescribed threshold value in order to classify a candidate image region as a structured artifact or not. The prescribed threshold value can be determined by using empirical (trial and error) techniques; statistical modeling of structured artifacts based upon analysis of real and/or synthesized images; supervised, semi-supervised, or unsupervised learning procedures; and/or any other suitable procedure.

Of course, the particular manner in which the values for each specified context-independent and context-dependent property are derived and/or used for classifying the candidate image regions is not limiting to the present invention, in its broader aspects. Any classification technique can be used for classifying the vectors of context-independent and/or context-dependent properties. Also, the manner in which the calculated values for each property or property set are used or combined in order to make decisions regarding candidate image regions is not limiting to the present invention, in its broadest aspects. For example, a Bayesian or approximate Bayesian decision process can be employed, such as the illustrative process described below.

A Bayesian decision is based on knowledge of the feature densities, the penalty function, and the class prior probabilities. Let P(x|ω₀) be the density (distribution) of the feature x for the class ω₀ of “false” artifacts. Let P(x|ω₁) be the density of feature x for the class ω₀ of “true” artifacts.

The penalty for making an incorrect decision (error) depends on the application. For example, for an interactive image artifact detection process, the penalties could be biased based on required user interaction time. Illustratively, the penalty (cost) C(1|0) for a false positive error could be made disproportionately smaller than the penalty C(0|1) for a false negative error, based on the rationale that the time required for a user to review the candidate image regions identified as containing an artifact and reject those that have been falsely identified as containing an artifact, may be much less than the time required for a user to examine the full image in order to identify missed artifacts. In a fully automated system, however, the penalties could be based on the resultant image quality. Illustratively, the penalty C(1|0) for a false positive error and the penalty C(0|1) for a false negative error can be set to the same or similar levels, assuming that both types of errors adversely affect the visual or aesthetic quality of the resultant image similarly, e.g., because false positive errors are automatically “corrected” by an image cleaning or inpainting (touch-up) process, thereby visibly contaminating the resultant “corrected” image much the same as an uncorrected (missed) artifact.

Taking these different penalties into account, then the Bayesian decision minimizes the expected cost by deciding that a given candidate image region contains an artifact or “defect” (ω₁) when the property x satisfies

P(x|ω₁)/P(x|ω₀)>(P(ω₀)C(1/0))/(P(ω₁)C(0/1));

and, otherwise, deciding that the given candidate image region does not contain an artifact (ω₀).

Equivalently, the Bayesian decision process can be implemented by taking the difference of the log likelihood log(P(x|ω₁))−log(P(x|ω₀)) and comparing it to a prescribed threshold.

In many Bayesian decision processes, a decision is based on two vectors of measurements, in this case, for example, measurements of context-independent properties (x₁) and measurements of context-dependent properties (x₂). Optimally, the measurements for both vectors would be concatenated into one vector x₁, x₂, and a joint distribution x for this joint vector would be learned and used for classification decisions. However, learning high dimensional distributions is both computationally expensive and requires many examples, which may not be available or feasible to obtain. Thus, for a practical implementation of the Bayesian decision process, the joint distribution function can be estimated using the common independence approximation, as

Prob(x₁, x₂)=Prob(x₁)Prob(x₂).

The distribution of properties for the Bayesian decision process can be approximated in the following illustrative manner, for both the measurements associated with the context-independent properties (vector (x₁)), and the measurements associated with the context-dependent properties (vector (x₂)).

Let y be a random variable equal to the average of the normalized values of the set of evaluated context-independent properties, which are “geometric photometric features” in the exemplary embodiment, and which are normalized so that each non-genuine candidate has an average of zero. Assume that for false candidate image regions (containing no defects), y is a Gaussian distribution (an assumption which is more accurate if more features are averaged), implying that log(P(y|ω₀))=const.−0.5y². Assume further that the distribution of y associated with genuine defects is uniform, implying that log(P(y|ω₁))=const. The intuitive decision process, preferring candidates with higher y values, is consistent with these assumptions.

Let z denote the context-based properties. Their densities P(z|ω₀), P(z|ω₁), can be approximated using a Parzen window approach, by taking numerous examples from the class of real artifacts (ω₁), representing them as impulses in feature space, and smoothing the representation using a smoothing window, thereby yielding a smooth function over the feature space, while approximating the real unknown density P(z|ω₁). Normalization may be desirable depending upon the smoothing window used. The density P(z|ω₀) can be approximated in a similar manner. If insufficient real artifacts are available in a particular image processing environment, the densities can be approximated using a simulation program to generate synthetic artifacts, or any other suitable technique.

Once the densities have been approximated, the Bayesian decision function becomes (assuming the common independence assumption has been adopted):

log(P(y|ω₁))−log(P(y|ω₀))+log(P(z|ω₁))−log(P(z|ω₀))

=y²log(P(z|ω₁))−log(P(z|ω₀))

>threshold.

Consider another example in which decisions regarding candidate image regions are based on calculated values for each property or property set. Properties of a candidate image region may be measured using empirical (trial and error) techniques; statistical modeling of structured artifacts based upon analysis of real and/or synthesized images; supervised, semi-supervised, or unsupervised learning procedures; and/or any other suitable procedure. For each candidate image region, a value can be calculated from the measured properties of that region, and the calculated value can be compared to a standard value. The comparison indicates the likelihood of a defect being genuine.

A Bayesian framework may be used to rank the candidate image regions. The candidate image regions may be ranked according to the difference between the expected cost of choosing the candidate image regions and the expected cost of not choosing the candidate image regions.

The joint distribution x, the class prior probabilities for the Bayesian decision process, and other statistics can be determined empirically, by means of simulation and/or statistical studies, or in any other suitable manner. These statistics may be learned in various ways. For example, a general learning may be performed for a class of general devices; a learning may be performed in the factory for a sample of devices; an on-site learning may be performed; etc. On-site learning may be performed by placing a document on a “dirty” scanner, scanning the document, and then rescanning the document at a different location (e.g., translated by a few millimeters) on the same scanner. Moving the document can allow scanner-based defects (which do not move with the page) to be distinguished from document-based defects. On-site learning may be performed instead or in addition by placing a document on a “dirty” scanner, scanning the document, cleaning the scanner, and then rescanning the document.

Although illustrative embodiments of the present invention have been described herein, it should be understood that many variations, modifications, and alternative embodiments thereof that may appear to those having ordinary skill in the pertinent art are encompassed by the present invention, as defined by the appended claims.

What is claimed is:

1. A method for detecting structured defects in an image, comprising:
examining at least one context-dependent property of a plurality of candidate image regions within the image; and,
determining which, if any, of the candidate image regions constitute or contain a defect based on the examination of the at least one context-dependent property.

2. The method as set forth in claim 1, further comprising identifying the candidate image regions prior to the examination.

3. The method as set forth in claim 2, wherein the candidate image regions are identified by generating a reference image from the original image, regions of specified shape and brightness having been removed from the reference image; and comparing the reference image to the original image.

4. The method as set forth in claim 3, wherein a gray level close morphological filter tailored to thin bright regions is used to generate the reference image from the original image.

5. The method as set forth in claim 1, further comprising examining at least one context-independent property of the candidate image regions.

6. The method as set forth in claim 5, wherein the least one context-independent property comprises a geometric property.

7. The method as set forth in claim 6, wherein the at least one geometric property is selected from a group comprised of eccentricity of the candidate image region, thinness of the candidate image region, and area of the candidate image region.

8. The method as set forth in claim 5, wherein the at least one context-independent property comprises a photometric property

9. The method as set forth in claim 8, wherein the at least one photometric property is selected from a group comprised of maximal gray level, minimal gray level, average gray level, gray level local maximality, and gray level local minimum.

10. The method as set forth in claim 5, wherein a value is determined for each examined context-independent property of each of the examined candidate image regions, the value being a measure of the likelihood that a defect is genuine.

11. The method as set forth in claim 10, wherein the values for each examined context-independent property of each of the examined candidate image regions are combined to produce a composite context-independent property value for each of the examined candidate image regions.

12. The method as set forth in claim 1, wherein, with respect to each examined candidate image region, the at least one context-dependent property comprises color or gray level uniformity between image regions of the image proximate to the candidate image region.

13. The method as set forth in claim 1, wherein, with respect to each examined candidate image region, the at least one context-dependent property comprises texture uniformity between image regions of the image proximate to the candidate image region.

14. The method as set forth in claim 1, wherein, with respect to each examined candidate image region, the at least one context-dependent property comprises co-linearity of that candidate image region with edgels of other image regions in the vicinity of that candidate image region.

15. The method as set forth in claim 1, wherein, with respect to each examined candidate image region, the at least one context-dependent property comprises the occurrence of a T-junction between that candidate image region and edge elements of other image regions in the vicinity of that candidate image region.

16. The method as set forth in claim 1, wherein a value is determined for each examined context-dependent property of each of the examined candidate image regions, the value being a measure of the likelihood that a defect is genuine.

17. The method as set forth in claim 16, wherein the values for each examined context-dependent property of each of the examined candidate image regions are combined to produce a composite context-dependent property value for each of the examined candidate image regions.

18. The method as set forth in claim 1, wherein the examination of the at least one context-independent property of the candidate image regions includes comparing the composite context-independent property value for each of the candidate image regions with a prescribed context-independent property threshold value, and eliminating from further examination candidate image regions that do not have a prescribed relationship with the prescribed context-independent property threshold value.

19. The method as set forth in claim 18, wherein the determination includes combining the values for each examined context-dependent property of each of the remaining candidate image regions to produce a composite context-dependent property value for each of the remaining candidate image regions.

20. The method as set forth in claim 19, wherein the determination further includes combining the composite context-independent value and the composite context-dependent value for each of the remaining candidate image regions to produce a composite property value for each of the remaining candidate image regions.

21. The method as set forth in claim 20, wherein the determination further includes using the composite property value of each of the remaining candidate image regions to make a decision as to whether each remaining candidate image region contains a defect, or not.

22. The method as set forth in claim 20, wherein the determination further includes using the composite property value of each of the remaining candidate image regions to rank the remaining candidate image regions according to the likelihood that they contain a defect.

23. The method as set forth in claim 20, wherein the determination further includes comparing the composite property value of each of the remaining candidate image regions to a prescribed composite property threshold value in order to make a decision as to whether each remaining candidate image region contains a defect, or not.

24. The method as set forth in claim 1, wherein the determination includes using a Bayesian decision process to make a decision as to whether respective ones of the candidate image regions contain a defect, or not.

25. The method as set forth in claim 1, wherein the determination includes using a Bayesian framework to rank the candidate image regions according to the difference between the expected cost of choosing the candidate image regions and the expected cost of not choosing the candidate image regions.

26. The method as set forth in claim 1, further comprising removing any detected defects from the image.

27. Apparatus for detecting defects in a digital image, the apparatus comprising a processor for filtering candidate image regions in the image by examining context-dependent properties of the candidate image regions.

28. The apparatus as set forth in claim 27, wherein the processor determines candidate image regions by generating a reference image from the original image, regions with specified characteristics having been removed from the reference image; and comparing the reference image to the original image.

29. The apparatus as set forth in claim 27, wherein the processor further examines at least one context-independent property of the candidate image regions.

30. The apparatus as set forth in claim 27, wherein the processor examines each candidate image region for at least one context-dependent property comprising color or gray level uniformity between image regions of the image proximate to the candidate image region.

31. The apparatus as set forth in claim 27, wherein the processor examines each candidate image region for at least one context-dependent property comprising texture uniformity between image regions of the image proximate to the candidate image region.

32. The apparatus as set forth in claim 27, wherein the processor examines each candidate image region for at least one context-dependent property comprising co-linearity of that candidate image region with edgels of other image regions in the vicinity of that candidate image region.

33. The apparatus as set forth in claim 27, wherein the processor examines each candidate image region for at least one context-dependent property comprising the occurrence of a T-junction between that candidate image region and edgels of other image regions in the vicinity of that candidate image region.

34. The apparatus as set forth in claim 27, wherein the processor determines a value for each examined context-dependent property of each of the examined candidate image regions, the value being a measure of the likelihood that a defect is genuine.

35. The apparatus as set forth in claim 27, wherein the processor also cleans defects identified as genuine from the image.

36. Apparatus comprising:
means for forming a digital image; and
a processor for detecting defects in the image by first filtering the image to identify candidate image regions suspected to constitute or contain defects, and then filtering the candidate image regions in the image by examining a combination of context-independent and context-dependent properties of the candidate image regions.

37. A program for causing a processor to detect defects in an image, the program comprising:
a candidate filtering function for examining one or more context-dependent properties of a plurality of candidate image regions within the image, and producing output data based upon the examination; and,
a candidate ranking function for ranking the candidate image regions according to the likelihood that they constitute or contain a defect, based upon the output data produced by the candidate filtering function.

38. An article for causing a processor to detect defects in an image, the article comprising memory encoded with a program for instructing the processor to detect defects in an image by examining one or more context-dependent properties of a plurality of candidate image regions within the image.

39. The article as set forth in claim 38, wherein at least one context-independent property of the candidate image regions is also examined.

40. The article as set forth in claim 38, wherein the at least one context-dependent property includes color or gray level uniformity between image regions of the image proximate to the candidate image region.

41. The article as set forth in claim 38, wherein the at least one context-dependent property includes texture uniformity between image regions of the image proximate to the candidate image region.

42. The article as set forth in claim 38, wherein the at least one context-dependent property includes co-linearity of that candidate image region with edgels of other image regions in the vicinity of that candidate image region.

43. The article as set forth in claim 38, wherein the at least one context-dependent property includes occurrences of T-junctions.
